(19) United States
(12) Patent Application Publication
(10) Pub. No.: US 2026/0347716 A1
(43) Pub. Date: Nov. 5, 2026

(54) METHOD FOR TREATING FUEL WITH ELECTROMAGNETIC WAVES

(71) Applicant: Nandan Kundetkar, THANE (WEST) (IN)

(72) Inventor: Nandan Kundetkar, THANE (WEST) (IN)

(21) Appl. No.: 19/195,766

(22) Filed: May 1, 2025

(51) Int. Cl. C10L 1/04

(52) U.S. Cl. CPC C10L 1/04; C10L 2230/22; C10L 2270/04; C10L 2290/36

(57) ABSTRACT

The present disclosure relates to a method for treating fuel comprising irradiating fuel with electromagnetic waves having a frequency of 10 terahertz to 500 terahertz. The treated fuel exhibits improved fuel economy, reduced emission of gases such as greenhouse gases and sulphur dioxide as well as reduced emission of particulate matter. The method of the present disclosure improves the life of engines and engine oils.

### TECHNICAL FIELD

The present disclosure relates to the field of fuel treatment. Particularly, the present disclosure relates to a method for treating fuel such as fossil fuels with electromagnetic waves to improve the fuel economy and reduce greenhouse gas emissions and particulate matter.

### BACKGROUND OF THE DISCLOSURE

The transportation sector is a major contributor to greenhouse gas emissions globally, accounting for a significant portion of total emissions. Internal combustion engines, which predominantly rely on fossil fuels, are the primary propulsion systems used in vehicles across various modes of transportation, including cars, trucks, ships, and aircraft. These engines combust fossil fuels releasing carbon dioxide (CO₂), methane (CH₄), and other pollutants, including particulate matter, into the atmosphere, thereby contributing to climate change and air pollution.

Efforts to mitigate greenhouse gas emissions from the transportation sector have been a focus of policymakers, researchers, and industry stakeholders worldwide. Strategies such as improving fuel efficiency, promoting alternative fuels, and advancing vehicle electrification have been pursued to reduce the carbon intensity of transportation activities. However, these efforts face challenges in achieving significant reductions in emission while meeting the demands of growing populations and economies.

Hence, there is a need for improved strategies to reduce fuel emissions and particulate matter from existing fossil fuels. The present disclosure attempts to address said need.

### STATEMENT OF THE DISCLOSURE

The present disclosure relates to a method for treating fuel comprising, irradiating fuel with electromagnetic (EM) waves having a frequency of 10 terahertz to 500 terahertz (THz). In some embodiments, the source of electromagnetic waves is located outside the fuel, i.e., the source of 10-500 THz EM waves is not in direct contact with the fuel.

### BRIEF DESCRIPTION OF THE ACCOMPANYING FIGURES

For the purpose that the disclosure may be readily understood and put into practical effect, reference will now be made to exemplary embodiments as illustrated with reference to the accompanying figures. The figures together with detailed description below, are incorporated in and form part of the specification, and serve to further illustrate the embodiments and explain various principles and advantages, in accordance with the present disclosure where:

FIG. 1 depicts fuel sample placed on the electromagnetic terahertz radiation device.

FIG. 2 depicts a device emitting electromagnetic terahertz radiation mounted on an off-vehicle fuel storage tank.

FIG. 3 depicts devices mounted on vehicle's on-board fuel tank.

### DETAILED DESCRIPTION OF THE DISCLOSURE

The term “a” or “an” refers to one or more of that entity, i.e. can refer to a single or plural referent. As such, the terms “a” or “an”, “one or more” and “at least one” are used interchangeably herein. In addition, reference to “an element” by the indefinite article “a” or “an” does not exclude the possibility that more than one of the elements is present, unless the context clearly requires that there is one and only one of the elements.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Throughout this specification, the word “comprise”, or variations such as “comprises” or “comprising” or “containing” or “has” or “having”, or “including but not limited to” wherever used, will be understood to imply the inclusion of a stated element, integer or step, or group of elements, integers or steps, but not the exclusion of any other element, integer or step, or group of elements, integers or steps.

Reference throughout this specification to “one embodiment”, “an embodiment”, or “some embodiments” means that a particular feature, structure or characteristic described in connection with the embodiment may be included in at least one embodiment of the present disclosure. Thus, the appearances of the phrases “in one embodiment”, “in an embodiment”, or “in some embodiments” in various places throughout this specification may not necessarily all refer to the same embodiment. It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination.

The term “about” or “approximately” as used herein encompasses variations of +/−10% and more preferably +/−5%, as such variations are appropriate for practicing the present invention.

The present inventors found that the treatment of fuel with EM waves having a frequency of about 10 to 500 terahertz (THz) improves fuel efficiency and reduces emission of green house gases and particulate matter.

Accordingly, in some embodiments, the present disclosure relates to a method for treating fuel comprising, irradiating fuel with electromagnetic waves having a frequency of about 10-500 THz, including values and ranges thereof. For example, in some embodiments, fuel is irradiated with EM waves having a frequency of about 10-500 THz, 10-450 THz, 10-400 THz, 10-350 THz, 10-300 THz, 10-250 THz, 10-200 THz, 10-150 THz, 10-100 THz, 10-50 THz, 25-500 THz, 25-400 THz, 25-350 THz, 25-300 THz, 25-250 THz, 25-200 THz, 25-150 THz, 25-100 THz, 25-50 THz, 50-500 THz, 50-450 THz, 50-400 THz, 50-350 THz, 50-300 THz, 50-250 THz, 50-200 THz, 50-150 THz, 50-100 THz, 100-500 THz, 100-450 THz, 100-400 THz, 100-350 THz, 100-300 THz, 100-250 THz, 100-200 THz, 100-150 THz, 150-500 THz, 150-450 THz, 150-400 THz, 150-350 THz, 150-300 THz, 150-250 THz, 150-200 THz, 200-500 THz, 200-450 THz, 200-400 THz, 200-350 THz, 200-300 THz, 200-250 THz, 250-500 THz, 250-450 THz, 250-400 THz, 250-350 THz, 250-300 THz, 300-500 THz, 300-450 THz, 300-400 THz, 300-350 THz, 350-500 THz, 350-450 THz, 350-400 THz, 400-500 THz, 400-450 THz, or about 400-500 THz. The generation of EM waves having a desired frequency is well within the skill of a person of ordinary skill in the art of EM waves.

In some embodiments, the fuel is irradiated with 10-500 THz frequency EM waves for about 1-90 minutes, including values and ranges therebetween, such as about 1-90 minutes, 1-80 minutes, 1-70 minutes, 1-60 minutes, 1-50 minutes, 1-40 minutes, 1-30 minutes, 1-20 minutes, 1-10 minutes, 5-90 minutes, 5-80 minutes, 5-70 minutes, 5-60 minutes, 5-50 minutes, 5-40 minutes, 5-30 minutes, 5-20 minutes, 5-10 minutes, 10-90 minutes, 10-80 minutes, 10-70 minutes, 10-60 minutes, 10-50 minutes, 10-40 minutes, 10-30 minutes, 10-20 minutes, 20-90 minutes, 20-80 minutes, 20-70 minutes, 20-60 minutes, 20-50 minutes, 20-40 minutes, 20-30 minutes, 30-90 minutes, 30-80 minutes, 30-70 minutes, 30-60 minutes, 30-50 minutes, 30-40 minutes, 40-90 minutes, 40-80 minutes, 40-70 minutes, 40-60 minutes, 40-50 minutes, 50-90 minutes, 50-80 minutes, 50-70 minutes, 50-60 minutes, 60-90 minutes, 60-80 minutes, 60-70 minutes, 70-90 minutes, 70-80 minutes, or about 80-90 minutes.

In some embodiments, the fuel may be treated in cycles. For example, in some embodiments, the fuel is treated with about 10-500 THz EM waves for 1-50 cycles, with 1 cycle raging from about 1 minute to about 90 minutes. In some embodiments, there could be a gap of about 1-90 minutes between the cycles. In some other embodiments, the cycles could be run continuously.

The frequency of EM waves and the treatment time can vary based on the factors like type and volume of the fuel, proximity of the radiation source from the fuel, and the like.

In some embodiments, the fuel is a fossil fuel. In some embodiments, the fuel is selected from automotive gasoline, automotive diesel, aviation gasoline, jet fuel, or marine fuel.

Automotive gasoline treated by the methods of the present disclosure includes both leaded and unleaded grades having different octane ratings. Jet fuel treated by the methods of the present disclosure includes Jet A, Jet A-1, Jet B, JP-8, and the like.

In some embodiments, the fuel being treated with the 10-500 THz EM waves is contained in an enclosed unit, referred to herein as a fuel containing unit. The fuel containing units include, but not limited to, fuel tank, fuel storage tank, fuel supply tank, fuel pipes and the like.

In some embodiments, the fuel containing unit that is being irradiated with the 10-500 THz EM waves may have a size ranging from about 1 gallon to 10,000 gallons or more, including values and ranges therebetween, such as about 1-8000 gallons, 1-5000 gallons, 1-3000 gallons, 1-1000 gallons, 1-500 gallons, 100-10000 gallons, 100-5000 gallons, 100-2000 gallons, 500-10000 gallons, 500-5000 gallons, 500-3000 gallons, 1000-10000 gallons, 1000-5000 gallons and so on. In some embodiments, the wall structure of the fuel containing unit may comprise a single-wall, a double-wall and may include internal baffles to minimize sloshing. In some embodiments, the wall material of the fuel containing unit may comprise a polymer or metal. In some embodiments, the fuel containing unit has a metal wall, wherein the metal is selected from aluminium, steel, or metallic alloys.

In some embodiments, the fuel containing unit that is being irradiated with 10-500 THz may be present above ground or underground; on a vehicle or outside the vehicle; etc.

In some embodiments, the source of 10-500 THz EM waves is not in direct contact with the fuel.

In some embodiments, the source of 10-500 THz EM waves is located/positioned outside the fuel.

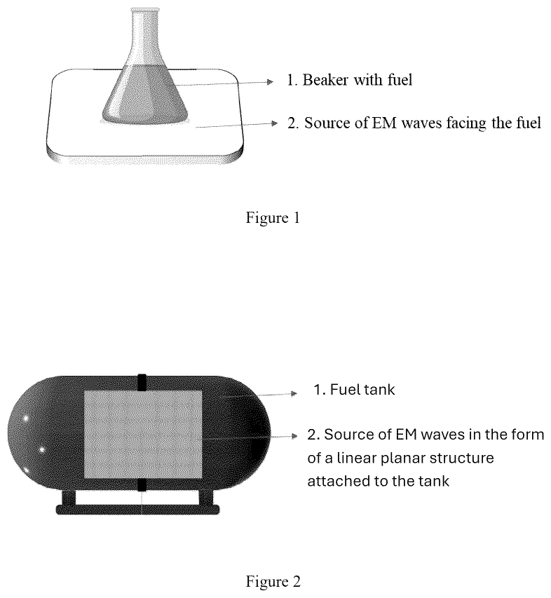

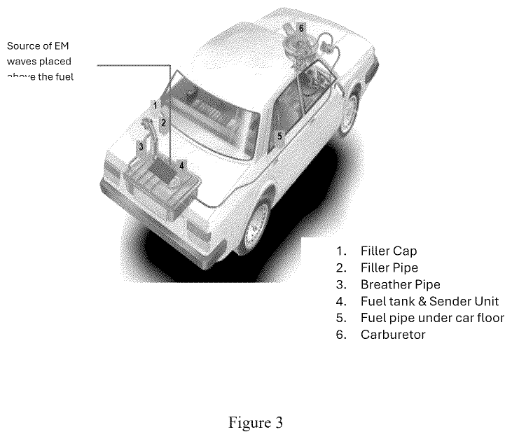

Accordingly, in some embodiments, the source emitting the 10-500 THz EM waves is placed/mounted on the outside walls of the fuel containing unit (FIGS. 1-3).

In some embodiments, the source emitting the 10-500 THz EM waves is located/positioned at a distance from the fuel containing unit.

In some embodiments, the source emitting the 10-500 THz EM waves is positioned facing the fuel containing unit.

Accordingly, in some embodiments, the fuel is present in a fuel tank and the source of 10-500 THz EM waves is placed/mounted on the outside wall of the fuel tank or at a distance from the fuel tank such that the source is facing the fuel tank.

In some embodiments, the fuel is present in a pipe and the source of 10-500 THz EM waves is placed/mounted on the outside wall of the fuel pipe or at a distance from the fuel pipe such that the source is facing the fuel pipe. In some embodiments, a fuel tank, fuel pipe, or both are located inside a vehicle such as a car, bus, train, aircraft, boat, ship, etc.

In some embodiments, the treatment of fuel according to the method of the present disclosure provides a reduction in the emission of carbon monoxide, carbon dioxide, nitrogen oxides, sulphur dioxides, methane, hydrocarbons, particulate matter and combinations thereof.

In some embodiments, the method of the present disclosure provides a treated fuel that exhibits a reduction in the emission of carbon monoxide by about 3 to 99%, including values and ranges therebetween, such as a reduction of about 3-99%, 3-90%, 3-80%, 3-70%, 3-60%, 3-50%, 3-40%, 3-30%, 3-20%, 3-10%, 5-90%, 5-70%, 5-50%, 5-30%, 5-20%, 10-99%, 10-80%, 10-70%, 10-60%, 10-50%, 10-40%, 10-30%, 10-20%, 20-99%, 20-90%, 20-80%, 20-70%, 20-60%, 20-50%, 20-40%, 20-30%, 30-99%, 30-90%, 30-80%, 30-70%, 30-60%, 30-50%, 30-40%, 40-99%, 40-90%, 40-80%, 40-70%, 40-60%, 40-50%, 50-99%, 50-90%, 50-80%, 50-70%, 50-60%, 60-99%, 60-90%, 60-80%, 60-70%, 70-99%, 70-90%, 70-80%, 80-99%, 80-90%, or about 90-99%.

In some embodiments, the method of the present disclosure provides a treated fuel that exhibits a reduction in the emission of nitrogen oxides (NOx) by about 8-100%, including values and ranges therebetween, such as a reduction of about 8-100%, 8-90%, 8-80%, 8-70%, 8-60%, 8-50%, 8-40%, 8-30%, 8-20%, 8-10%, 10-100%, 10-90%, 10-80%, 10-70%, 10-60%, 10-50%, 10-40%, 10-30%, 10-20%, 20-100%, 20-90%, 20-80%, 20-70%, 20-60%, 20-50%, 20-40%, 20-30%, 30-100%, 30-90%, 30-80%, 30-70%, 30-60%, 30-50%, 30-40%, 40-100%, 40-90%, 40-80%, 40-70%, 40-60%, 40-50%, 50-100%, 50-90%, 50-80%, 50-70%, 50-60%, 60-100%, 60-90%, 60-80%, 60-70%, 70-100%, 70-90%, 70-80%, 80-100%, 80-90%, or about 90-100%.

In some embodiments, the method of the present disclosure provides a treated fuel that exhibits a reduction in the emission of methane by about 3-60%, including values and ranges therebetween, such as a reduction of about 3-60%, 3-50%, 3-40%, 3-30%, 3-20%, 3-10%, 10-60%, 10-50%, 10-40%, 10-30%, 10-20%, 20-60%, 20-50%, 20-40%, 20-30%, 30-60%, 30-50%, 30-40%, 40-60%, 40-50%, or about 50-60%.

In some embodiments, the method of the present disclosure provides a treated fuel that exhibits a reduction in the emission of total hydrocarbons (THC) by about 3-40%, including values and ranges therebetween, such as a reduction of about 3-40%, 3-30%, 3-20%, 3-10%, 5-40%, 5-30%, 5-25%, 5-20%, 5-15%, 10-40%, 10-30%, 10-20%, 20-40%, 20-30%, or about 30-40%.

In some embodiments, the method of the present disclosure provides a treated fuel that exhibits a reduction in the emission of sulphur oxides (SOx) by about 3 to 99%, including values and ranges therebetween, such as a reduction of about 3-99%, 3-90%, 3-80%, 3-70%, 3-60%, 3-50%, 3-40%, 3-30%, 3-20%, 3-10%, 10-99%, 10-90%, 10-80%, 10-70%, 10-60%, 10-50%, 10-40%, 10-30%, 10-20%, 20-99%, 20-90%, 20-80%, 20-70%, 20-60%, 20-50%, 20-40%, 20-30%, 30-99%, 30-90%, 30-80%, 30-70%, 30-60%, 30-50%, 30-40%, 40-99%, 40-90%, 40-80%, 40-70%, 40-60%, 40-50%, 50-99%, 50-90%, 50-80%, 50-70%, 50-60%, 60-99%, 60-90%, 60-80%, 60-70%, 70-99%, 70-90%, 70-80%, 80-99%, 80-90%, or about 90-99%.

In some embodiments, the method of the present disclosure provides a treated fuel that exhibits a reduction in the emission of particulate matter by about 10-50%, including values and ranges therebetween, such as a reduction of about 10-50%, 10-40%, 10-30%, 10-20%, 20-50%, 20-40%, 20-30%, 30-50%, 30-40%, or about 40-50%.

In some embodiments, the method of the present disclosure provides a treated fuel that exhibits improved fuel economy. In some embodiments, the fuel economy is improved by about 5-35%, such as by about 5-30%, 5-25%, 5-20%, 5-15%, 5-10%, 10-35%, 10-30%, 10-25%, 10-20%, 10-15%, 15-35%, 15-30%, 15-25%, 15-20%, 20-35%, 20-30%, 20-25%, 25-35%, 25-30%, or about 30-35%, including values and ranges therebetween.

In some embodiments, the methods of the present disclosure improve the life of engine and engine oil. For example, in some embodiments, engine oil of the vehicles employing the fuel treated by the 10-500 THz EM waves according to the present disclosure shows lower levels of elements such as iron, copper, tin, aluminum, chromium, and molybdenum, while concurrently showing higher levels of zinc, phosphorus, calcium, boron, and magnesium. This oil analysis indicates a reduction in engine wear and an increase in engine oil life.

### ADVANTAGES

The methods of the present disclosure provide several advantages/benefits, including, but not limiting to:
Improved fuel economy.
Reduced emissions of greenhouse gases such as CO, CO₂, methane, nitrogen oxides, sulphur oxides.
Reduced emissions of hydrocarbons.
Reduced emission of particular matter.
Reduced exhaust gas temperatures.
Increased engine oil life.
Increased engine life.

Additional embodiments and features of the present disclosure will be apparent to one of ordinary skill in art based on the description provided herein. The embodiments herein provide various features and advantageous details thereof in the description. Descriptions of well-known/conventional methods and techniques are omitted so as to not unnecessarily obscure the embodiments herein.

The foregoing description of the specific embodiments fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments in this disclosure have been described in terms of preferred embodiments, those skilled in the art will recognize that the embodiments herein can be practiced with modification within the spirit and scope of the embodiments as described herein.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. As used in this specification and the appended claims, the singular forms “a,” “an” and “the” includes both singular and plural references unless the content clearly dictates otherwise. The use of the expression ‘at least’ or ‘at least one’ suggests the use of one or more elements or ingredients or quantities, as the use may be in the embodiment of the disclosure to achieve one or more of the desired objects or results. As such, the terms “a” (or “an”), “one or more”, and “at least one” can be used interchangeably herein.

Numerical ranges stated in the form ‘from x to y’ include the values mentioned and those values that lie within the range of the respective measurement accuracy as known to the skilled person. If several preferred numerical ranges are stated in this form, of course, all the ranges formed by a combination of the different end points are also included.

As regards the embodiments characterized in this specification, it is intended that each embodiment be read independently as well as in combination with another embodiment. For example, in case of an embodiment 1 reciting 3 alternatives A, B and C, an embodiment 2 reciting 3 alternatives D, E and F and an embodiment 3 reciting 3 alternatives G, H and I, it is to be understood that the specification unambiguously discloses embodiments corresponding to combinations A, D, G; A, D, H; A, D, I; A, E, G; A, E, H; A, E, I; A, F, G; A, F, H; A, F, I; B, D, G; B, D, H; B, D, I; B, E, G; B, E, H; B, E, I; B, F, G; B, F, H; B, F, I; C, D, G; C, D, H; C, D, I; C, E, G; C, E, H; C, E, I; C, F, G; C, F, H; C, F, I, unless specifically mentioned otherwise.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

All references, articles, publications, general disclosures etc. cited herein are incorporated by reference in their entireties for all purposes. However, mention of any reference, article, publication etc. cited herein is not, and should not be taken as, an acknowledgment or any form of suggestion that they constitute valid prior art or form part of the common general knowledge in any country in the world.

Further, while the instant disclosure is susceptible to various modifications and alternative forms, specific aspects thereof has been shown by way of examples and drawings and are described in detail below. However, it should be understood that it is not intended to limit the invention to the particular forms disclosed, but on the contrary, the intention is to cover all modifications, equivalents, and alternatives falling within the spirit and the scope of the invention.

### EXAMPLES

The present disclosure is further described with reference to the following examples, which are only illustrative in nature and should not be construed to limit the scope of the present disclosure in any manner.

### Example 1

Automotive gasoline was treated with 100-300 THz EM radiation. The treated fuel was tested using a 2010 Honda City sedan per the FTP-75 (Federal test procedure 75) protocol. These tests revealed a 25 percent decrease in carbon monoxide emission, a 4 percent decrease in THC, 28 percent decrease in NOx, and a 44 percent decrease in the particulate matter mass.

### Example 2

Automotive gasoline was treated with 100-300 THz EM radiation. The treated fuel was tested using a 2019 Honda Civic sedan powered by a regular gasoline engine (2.0 Liter) using the FTP and HWFE (Highway Fuel Economy) standardized testing regimes. The emission of NOx was reduced by 47 and 93 percent using FTP-75 and HWFE tests respectively. Furthermore, a 29-60 percent reduction in methane was observed using FTP-75 and HWFE tests respectively.

### Example 3

Automotive gasoline was treated with 100-300 THz EM radiation. The treated fuel was tested using a 2010 Honda City sedan using the FTP standardized testing regimes. The analysis of tailpipe emissions is shown below.

TABLE 1

| | CO | NOx | THC | THC + NOx | NM HC | CO₂ | | PN |
|---|---|---|---|---|---|---|---|---|
| Test | (mg/mile) | (mg/mile) | (mg/mile) | (mg/mile) | (mg/mile) | (g/mile) | PM | (#mile) |
| Without | 803.479 | 162.401 | 46.171 | 208.572 | 39.125 | 258.592 | 15.310 | 1.35 × E¹¹ |
| treatment | | | | | | | | |
| With | 599.744 | 116.153 | 44.383 | 160.536 | 38.948 | 259.654 | 8.554 | 1.16 × E¹¹ |
| treatment | | | | | | | | |

### Example 4

Diesel was treated with 200-500 THz EM radiation. The treated diesel was tested using a 2015 Chevrolet truck with 6.6L Duramax diesel engine. Over 10% improvement in fuel economy was noted.

### Example 5

Multiple field trials were conducted by employing the method of the present disclosure. The fuels tested included aviation turbine fuel (Jet-A), automotive diesel, aviation gasoline (100LL), and automotive gasoline.

Aviation Turbine Fuel: Two Jet-A powered turbine engines: a Pratt & Whitney PT-6A engine and a Honeywell F-109 engine were used. Jet-A fuel was treated with 150-350 THz EM radiation. When pre- and post-treatment performance was compared, the inter-stage turbine temperature (ITT) on the F-109 was 23 to 53 °F cooler and it was 25 to 63 °C cooler on the PT-6A post-treatment. The F-109 demonstrated a 4% improvement while the PT-6A demonstrated a 7% improvement in fuel economy.

Automotive Diesel: Diesel was treated with 200-500 THz EM radiation. Laboratory tests, based on the MIDC test cycle, conducted at a third-party testing facility revealed that post-treatment, there was a 3 percent reduction in CO (g/km), 25 percent reduction in THC (g/km), 9 percent reduction in NOx (g/km), 11 percent reduction in HC+NOx (g/km), 24 percent reduction in particulate matter (g/km), and 1 percent gain in fuel economy (g/km). Subsequently, diesel-powered school buses were tested in a field trial. A pre- and post-comparison of the fuel economy indicated 18-31 percent improvement. Analysis of the exhaust gases indicated a 35 percent reduction in carbon monoxide, 38 percent reduction in carbon dioxide and 100 percent elimination of nitrogen dioxide. Spectrometric analysis of the engine oil indicated a lower presence of metallic elements such as iron, copper, tin, aluminum, chromium, and molybdenum. Concurrently, higher levels of zinc, phosphorus, as well as calcium, boron, and magnesium were noted. This oil analysis indicated reduction in engine wear and increase in engine oil life.

Aviation Gasoline (100LL): Aviation gasoline was treated with 150-350 THz EM radiation. A Piper Archer aircraft with Lycoming O-360 was used in this trial. A pre- and post-comparison of the fuel sample against the ASTM D910 indicated that fuel economy improved between 5-7 percent, the exhaust gas temperature decreased by up to 124 degrees F, and the greenhouse gas emissions decreased by up to 28 percent.

Automotive Gasoline: Automotive gasoline-powered passenger vehicles were used for this trial. Automotive gasoline was treated with 150-350 THz EM radiation A pre- and post-comparison of trial runs on a 2021 Jeep Compass indicated almost 17 percent improvement in fuel economy. Similarly, an emissions test on a 2020 Toyota Corolla achieved an 80-99 percent decrease in NOx, SO₂, and CO.

The tests and data disclosed in the above examples demonstrate that a consistent and significant improvement in fuel economy and reduction in greenhouse gas emissions can be achieved with the 10-500 THz radiation treatment of the present disclosure.

We claim:

1. A method for treating fuel comprising, irradiating fuel with electromagnetic waves having a frequency of 10 terahertz to 500 terahertz.

2. The method of claim 1, wherein the fuel is irradiated with electromagnetic waves for about 1-90 minutes.

3. The method of claim 1, wherein the source of electromagnetic waves is not in direct contact with the fuel.

4. The method of claim 1, wherein the source of electromagnetic waves is located outside the fuel.

5. The method of claim 1, wherein the fuel is stored in a storage unit and the source of the electromagnetic waves is positioned facing the storage unit.

6. The method of claim 1, wherein the fuel is transported by a pipe and the source of the electromagnetic waves is positioned facing the pipe.

7. The method of claim 1, wherein the fuel is automotive gasoline, automotive diesel, aviation gasoline, jet fuel, or marine fuel.

8. The method of claim 1, wherein the method provides a treated fuel that exhibits a reduction in the emission of carbon monoxide.

9. The method of claim 1, wherein the method provides a treated fuel that exhibits a reduction in the emission of nitrogen oxides.

10. The method of claim 1, wherein the method provides a treated fuel that exhibits a reduction in the emission of methane.

11. The method of claim 1, wherein the method provides a treated fuel that exhibits a reduction in the emission of sulphur oxides.

12. The method of claim 1, wherein the method provides a treated fuel that exhibits a reduction in the emission of particulate matter.

13. The method of claim 1, wherein the method provides a treated fuel that exhibits a reduction in the emission of hydrocarbons.

14. The method of claim 1, wherein the method provides a treated fuel that exhibits improved fuel economy.

15. The method of claim 1, wherein the method provides a treated fuel that improves the engine life.
